(19) United States
(12) Patent Application Publication
(10) Pub. No.: US 2018/0169457 A1
(43) Pub. Date: Jun. 21, 2018

(54) ASSEMBLY FOR ACTIVE AND RESISTIVE JOINT REHABILITATION EXERCISES

(71) Applicant: Jagdeep Singh, South Boston, VA (US)

(72) Inventor: Jagdeep Singh, South Boston, VA (US)

(21) Appl. No.: 15/840,800

(22) Filed: Dec. 13, 2017

Related U.S. Application Data
(60) Provisional application No. 62/437,294, filed on Dec. 21, 2016.

(51) Int. Cl. A63B 21/012; A61H 1/02; A63B 21/00; A63B 21/015; A63B 23/04

(52) U.S. Cl. CPC A63B 21/0125; A63B 2071/0694; A63B 21/4015; A63B 21/00178; A63B 21/4045; A63B 21/015; A63B 21/00069; A63B 23/0494; A63B 21/4034; A61H 2205/104; A61H 2201/1642; A61H 2201/0192; A61H 2201/0157; A63B 2209/10; A63B 2208/0233; A61H 1/024

(57) ABSTRACT

An assembly for active and resistive joint rehabilitation exercises enables a joint, such as a knee, to flex in a controlled, curvilinear motion, while enabling adjustable resistance. In this manner, the joint practices both resistive exercises and active exercises for strengthening, as well as redeveloping range of motions. A base member with stabilizing bars provides lateral support for the assembly. The base member has a recessed docking region. A bracket detachably attaches in the docking region and joins the rails to base member. In this manner, the rails can detachably release from the base member. A lever and a base handle enable assembly to be moved and tilted. A vehicle comprises wheels that ride the rails while the foot rests therein, so that joint extends and retracts the curvilinear motion. An adjustment member increases and decreases friction coefficient between the wheels and rails for adjustable resistance of curvilinear motions.

### CROSS REFERENCE OF RELATED APPLICATIONS

This application claims the benefits of U.S. provisional application No. 62/437,294, filed Dec. 21, 2016 and entitled ACTIVE AND RESISTIVE EXERCISE JOINT REHABILITATION APPARATUS, which provisional application is incorporated by reference herein in its entirety.

### FIELD OF THE INVENTION

The present invention relates generally to an assembly for active and resistive joint rehabilitation exercises. More so, the assembly for active and resistive joint rehabilitation exercises enables a joint, such as a knee or ankle, to flex in a continuous, curvilinear motion, while also enabling adjustable resistance during the curvilinear motion; whereby the assembly comprises a base member with stabilizing bars for lateral support; whereby the base member forms a recessed docking region, such that a bracket detachably attaches in the docking region to join the rails to base member; whereby the assembly further comprises a lever and a base handle to enable the assembly to be moved and tilted; whereby the assembly further comprises a vehicle having wheels that ride the rails while the foot rests therein, so that joint extends and retracts the curvilinear motion; and whereby the assembly further comprises an adjustment member to increase and decrease a friction coefficient between the wheels and rails for adjustable resistance of curvilinear motions.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, the limbs are the human body portions that most frequently contact with external environment, and are therefore most easily subject to injury. People with an injured knee, post operated knee patients, (total knee arthroplasties, open, mini invasive and arthroscopic ACL/PCL, meniscal, joint and muscle repairs), seek innovative options for managing knee pain, through therapeutic exercises to rehabilitate soft tissue injuries, degenerative joint conditions, and restore joint ROM, strength, and modulate pain to increase limb function pre and post operatively.

It is known in the art that active motion enables a user the complete movement of the limb, while passive movement offers only partial movement of the limb, and also requires external equipment or therapists to assist the patient. The adjustable resistance and active exercise offered by the assembly is a great advantage over the passive exercise equipment of the prior art. The assembly also allows for the adjustment of progressive resistance so as to create a heightened sense of proprioceptive awareness in those muscles and joints that are meant to be targeted depending upon the particular movement pattern being exercised.

Those skilled in the art will recognize that more than 600,000 knee replacements are performed each year in United States as per Agency for Healthcare Research and Quality. Due to medical advancement, the average hospital stay is not more than 2-3 days following surgery. Depending on patient's mobility status the patient is often discharged either with home health or outpatient skilled physical therapy services. The frequency of these services is often only 2 to 3 times per week while and the rest of the days the patient is advised to work on the home exercise program (HEP) by themselves or with the help of caregiver if available.

In rehabilitation of the limbs, and especially the knee, the primary achievements that the orthopedic surgeon expects from the patients are: to gain active knee range of motion (ROM) of flexion and extension as soon as possible; to be more active and mobile and be self-sufficient and independent as soon as possible; and to improve strength in the knee joint. For this purpose, some patients go home with the Continuous Passive Motion (CPM) machine, which is used to improve ROM of the knee joint.

The CPM, however, has its own drawbacks. For example, the CPM equipment that provides passive motion to the knee joint, which means it does not assist in active and resistive ROM, thus does not promote strengthening. The CPM equipment is also heavy and bulky, due to which patient will need caregiver's assistance to set up the machine. And finally, the CPM equipment is not functional unless the patient lies in the bed for 2-3 hours to use it. CPM is also very expensive to purchase, buy, or rent, so insurance companies only cover it for only few days following the surgery.

Unfortunately, patients who cannot afford to rent or who cannot attain the privilege of using the CPM, have a hard time performing their exercises by themselves and thus need assistance from their caregivers. Not to mention the pain and the lower extremity weakness that is associated with the knee replacement making it difficult for patients to perform the exercises by themselves. Some patients who do not have caregivers to assist them with their HEP put themselves in an unsafe situation while performing the HEP or sometimes simply unable to perform the HEP.

Other proposals have involved exercise devices and methods for rehabilitating the joints; and especially for post operated knee patients. The problem with these exercising devices is that they do not enable an active range of motion independently without any assistance required from caregiver for set up and also by providing friction free surface. Also, the cited exercise devices do not provide resistance during range of motion to facilitate further strengthening of quadriceps and hamstring. Even though the above cited exercise devices meet some of the needs of the market, an assembly for active and resistive joint rehabilitation exercises that is effective for practicing both active and resistive joint rehabilitation exercises, so that a joint, such as a knee, can flex in a controlled, curvilinear motion is still desired.

### SUMMARY

Illustrative embodiments of the disclosure are generally directed to an assembly for active and resistive joint rehabilitation exercises. The assembly is effective for practicing both active and resistive joint rehabilitation exercises, so that a joint, such as a knee, can flex in a controlled, curvilinear motion. The assembly also enables adjustable resistance during this motion. In this manner, the joint practices both resistive exercises and active exercises for strengthening, as well as redeveloping range of motions.

In one non-limiting embodiment, a base member with stabilizing bars provides lateral support for the assembly. The base member has a recessed docking region. A bracket detachably attaches in the docking region and joins the rails to base member. In this manner, the rails can detachably release from the base member. A lever and a base handle enable assembly to be moved and tilted. A vehicle comprises wheels that ride the rails while the foot rests therein, so that joint extends and retracts the curvilinear motion. An angle bar indicates a radius angle of the vehicle relative to the pair of rails. An adjustment member increases and decreases friction coefficient between the wheels and rails for adjustable resistance of curvilinear motions.

In one aspect, the base handle has a generally T-shape.

In one aspect, the base handle comprises a length adjustable handle configured for gripping.

In one aspect, the lever is generally elongated and rigid.

In one aspect, the lever manipulates the assembly in a tilting motion.

In one aspect, the vehicle is sized and dimensioned to enable receiving a foot.

In one aspect, the bracket detachably attaches to the recessed docking region of the base member.

In one aspect, the at least one wheel comprises at least four wheels.

In one aspect, the limb fastening mechanism enables detachable attachment of a limb to the limb surface of the vehicle.

In one aspect, the limb fastening mechanism is a hook and loop fastener.

In one aspect, the adjustment member is operable to displace the at least one wheel in a first direction to increase the friction coefficient between the at least one wheel and the pair of rails.

In one aspect, the adjustment member is operable to displace the at least one wheel in a second direction to decrease the friction coefficient between the at least one wheel and the pair of rails.

In one aspect, the adjustment member comprises a rotatable knob that adjusts the position of the wheels to vary the friction coefficient with the rails.

One objective of the present invention is to allow the limbs to flex along a curvilinear path to in a both active and resistive exercise.

Another objective is to increase the range of motion and the strength of a knee joint or elbow joint with active and resistive exercises.

Another objective is to provide an active and resistive joint rehabilitation assembly that is mobile and lightweight.

Another objective is to provide a curvilinear pair of rails that are detachable from the base member for facilitated stowage.

Another objective is to provide a curvilinear pair of rails that telescopically adjust in length.

Yet another objective is to provide adjustable resistance of the friction coefficient between the rails and wheels through use of a rotatable knob.

Yet another objective is to enable adjustment of progressive resistance so as to create a heightened sense of proprioceptive awareness in targeted muscles and joints, depending upon the particular movement pattern being exercised.

Yet another objective is to fasten the foot to the vehicle with a secure fastener, such as a hook and loop fastener (Velcro™).

Yet another objective is to provide an easy to use joint rehabilitation exercise assembly.

Yet another objective is to provide a mobile joint rehabilitation exercise assembly.

Yet another objective is to provide an inexpensive to manufacture joint rehabilitation exercise assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary assembly for active and resistive joint rehabilitation exercises, showing a user flexing the knee while the leg travels a curvilinear path, in accordance with an embodiment of the present invention;

FIG. 2 illustrates a perspective view of an exemplary assembly for active and resistive joint rehabilitation exercises, in accordance with an embodiment of the present invention;

FIG. 3 illustrates a left side view of the assembly for active and resistive joint rehabilitation exercises shown in FIG. 2, in accordance with an embodiment of the present invention;

FIG. 4 illustrates a top pan view of the assembly for active and resistive joint rehabilitation exercises shown in FIG. 2, in accordance with an embodiment of the present invention;

FIG. 5 illustrates a frontal view of the assembly for active and resistive joint rehabilitation exercises shown in FIG. 2, in accordance with an embodiment of the present invention;

FIG. 6 illustrates a blow up view of the assembly for active and resistive joint rehabilitation exercises shown in FIG. 2, in accordance with an embodiment of the present invention;

FIG. 7 illustrates a blow up view of an exemplary base member, in accordance with an embodiment of the present invention;

FIG. 8 illustrates a blow up view of an exemplary pair of rails, in accordance with an embodiment of the present invention;

FIG. 9 illustrates a blow up view of the pair of rails, shown in FIG. 8, separated into rail sections, in accordance with an embodiment of the present invention; and

FIG. 10 illustrates a perspective view of an exemplary angle bar, in accordance with an embodiment of the present invention.

Like reference numerals refer to like parts throughout the various views of the drawings.

### DETAILED DESCRIPTION OF THE INVENTION

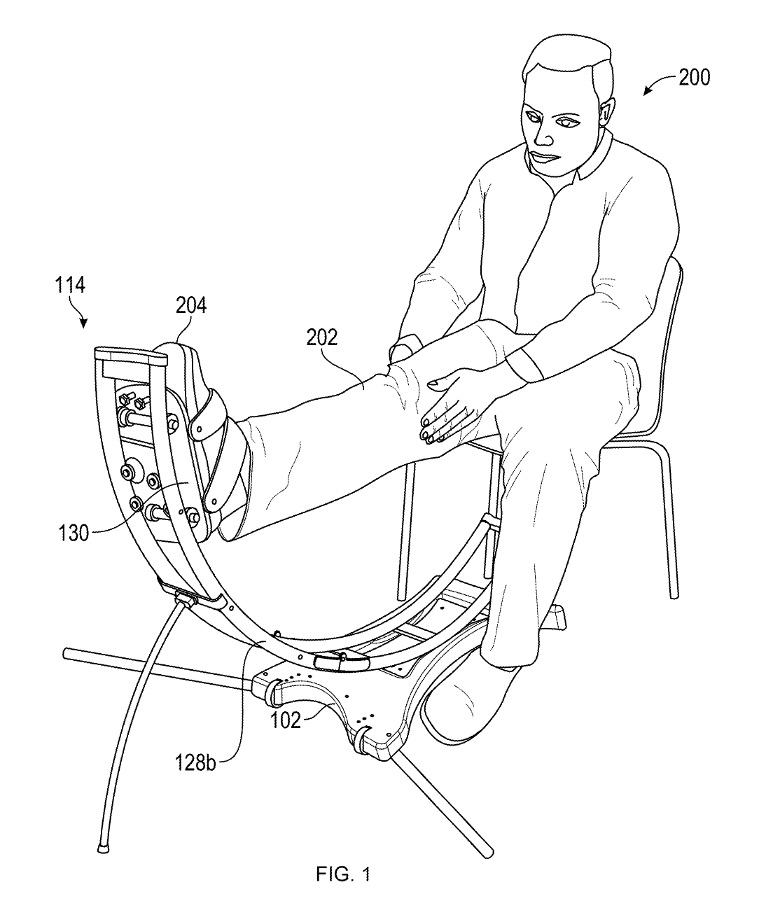

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-10, an active and resistive exercise joint rehabilitation assembly 100 is adapted to enable a joint 202, such as a knee, to flex, bend, retract, and fully extend in a curvilinear motion. Assembly also enables adjustable resistance to the joint 202 as the limb travels the curvilinear motion.

As FIG. 1 illustrates, assembly is efficacious for rehabilitation of a knee, allowing the limbs to flex along a curvilinear path to in a both active and resistive exercise. The limb terminus 204 detachably couples in a vehicle 130 that travels along a pair of curvilinear-shaped rails 128a-d. The limb moves in a back-and-forth motion along the curvilinear path to flex the joint 202. The resistance to the limb's motion may be adjusted by increasing or decreasing the friction coefficient between the rails 128a-d and at least one wheel 136a, 136b on the vehicle 130.

This type of active and resistive exercise may be helpful post-rehabilitation, for example, after a knee replacement surgery. Assembly 100 is unique in that it offers more than just passive exercise of the joint 202, but also enables the joint 202 to practice resistive exercises and active exercises with adjustable resistance. Further, the use of a curvilinear path and adjustable resistance is efficacious for strengthening joint 202, as well as redeveloping a full range of motions for joint 202.

This type of active and resistive exercise is efficacious in strengthening the joint 202, as well as redeveloping the range of motions for joint 202. In one exemplary use, assembly 100 facilitates active knee motion of flexion and extension, thereby increasing strength of quadriceps and hamstring muscles. Assembly 100 is unique in that it is based on active and resistive ranges of motions, in addition to the passive motions known in the art. This is significantly different than the prior art exercise machines that are based on passive motion.

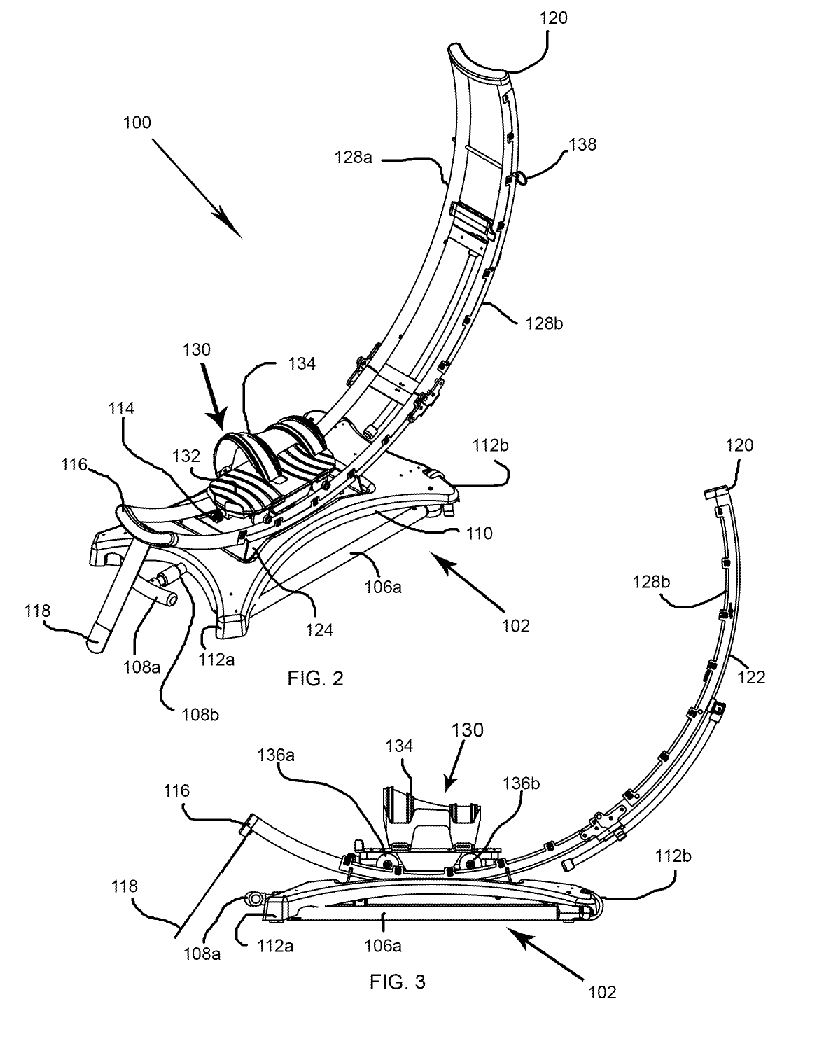

Turning now to FIG. 2, assembly 100 provides a base member 102 that rests firmly on a ground surface, forming a stable foundation as the joint 202 exercises along the curvilinear path. In one non-limiting embodiment, base member 102 is defined by a narrow center region 110 and a pair of base ends 112a, 112b. In one non-limiting embodiment, base ends 112a-b may be wider than center region 110. Base member 102 may have a generally elongated rectangular shape. Though in other embodiments, other shapes for base member 102 may also be used.

In one non-limiting embodiment referenced in FIG. 3, a pair of stabilizer bars 106a, 106b extend along the length of base member 102. Stabilizer bars 106a-b help provide lateral stability to base member 102. Stabilizer bars 106a-b also provide a gripping surface for user 200 while exercising. A pair of stabilizer bar fasteners 142a, 142b may be used to help fasten the pair of stabilizer bars to the base member; and further to prevent rotational movement by stabilizer bars 106a-b.

Suitable materials for base member 102 may include, without limitation, a rigid polymer, a metal, a metal alloy, rubber, and fiberglass. In any case, base member 102 is generally lightweight to enable easy mobility. In one embodiment, base member 102 comprises a recessed docking region 104 that receives a curvilinear pair of rails 128a-d, as described below.

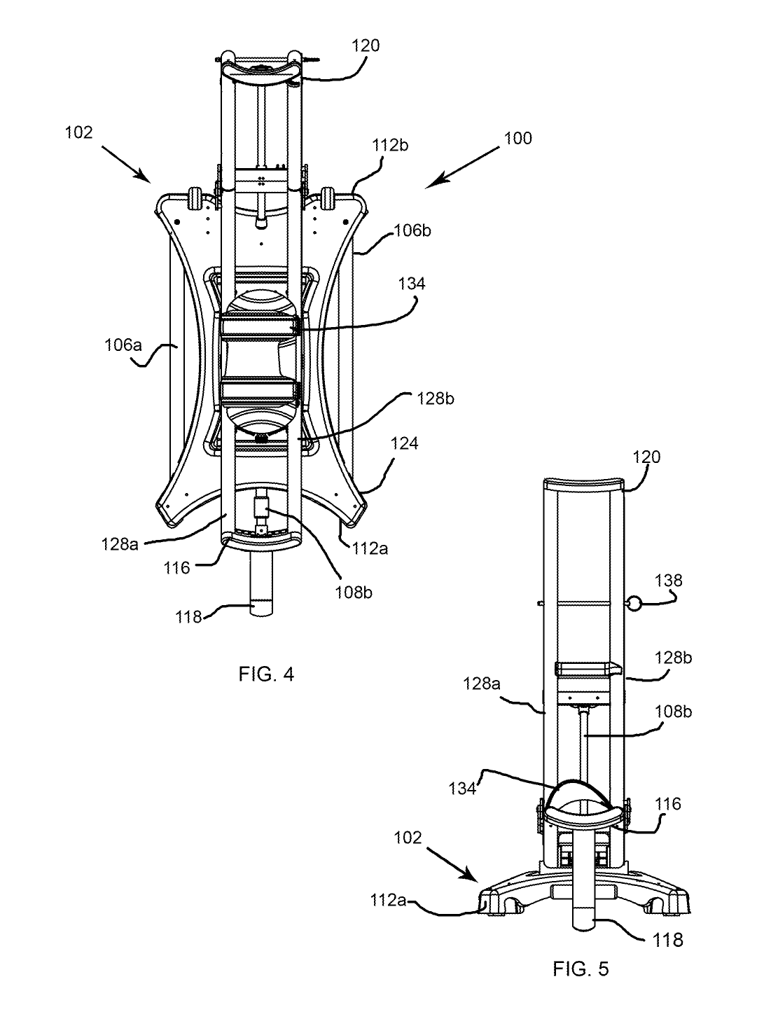

As shown in FIGS. 4 and 5, base member 102 may form a recessed docking region 104. Docking region 104 is sized and dimensioned to receive and secure a curvilinear pair of rails 128a-d. Rails 128a-d detachably attach to base member 102, forming a curvilinear path that the limb follows to flex the joint 202.

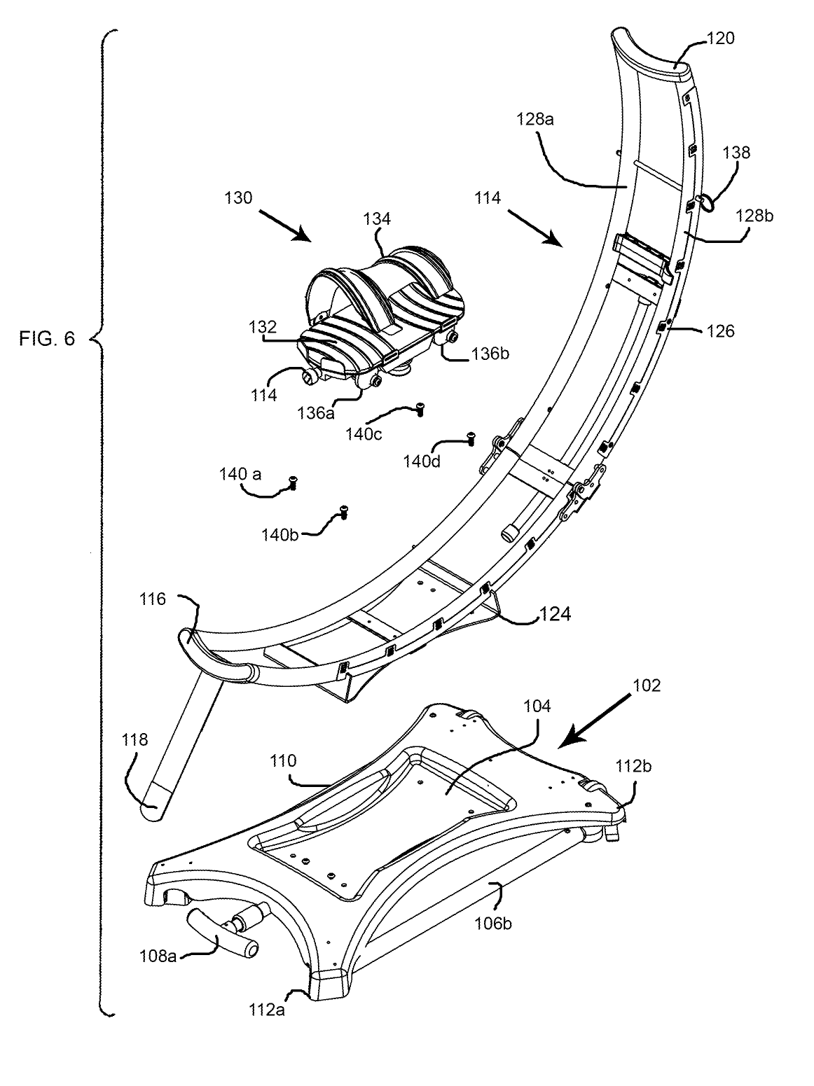

In another non-limiting embodiment shown in FIG. 6, assembly 100 may also include a base handle 108a, 108b on base member 102 is manipulated to enable extend and retract from the base member 102, so as to enable manipulation of assembly 100. Base handle 108a, 108b may include a T-shape that can be gripped to carry the assembly 100. A handle end 108a allows manipulation, while a pipe end 108b extends beneath the rails.

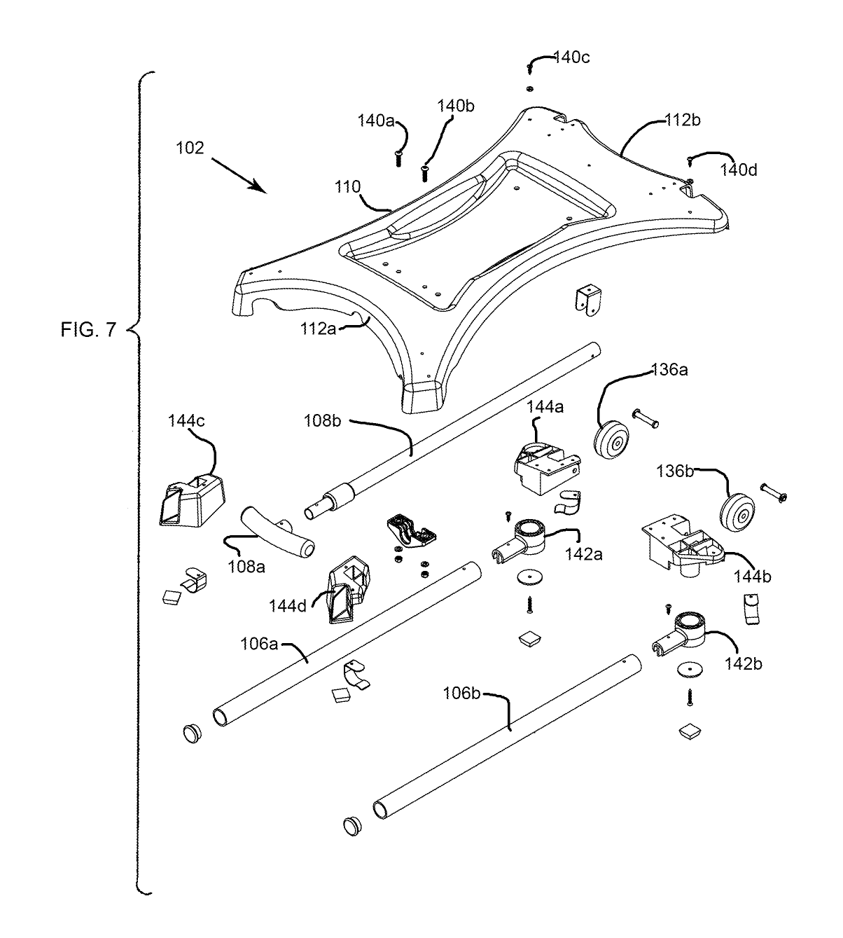

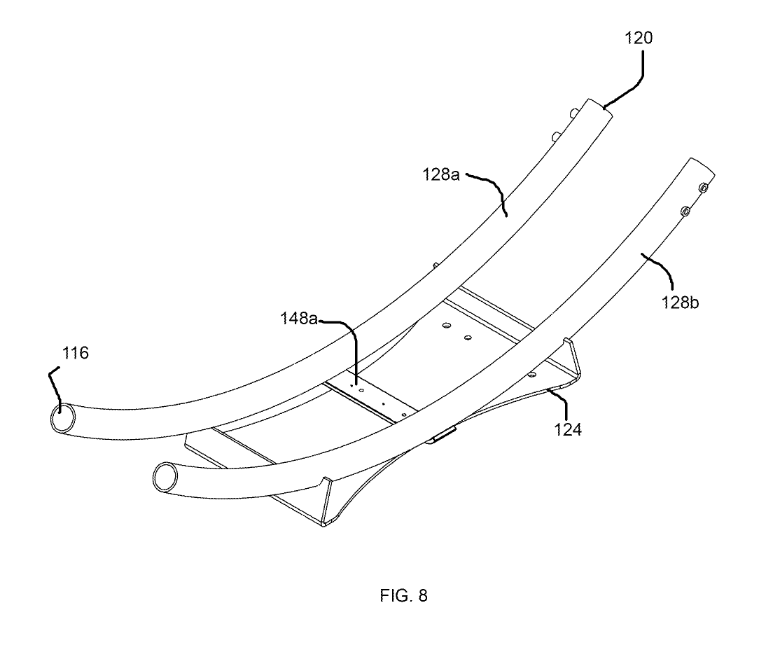

In yet another non-limiting embodiment shown in FIG. 7, a lever 118 extends from end 112a of base member 102. Lever 118 is generally elongated and rigid. Lever 118 may be used to manipulate, by lifting, sliding, and tilting assembly 100, as needed. For example, assembly 100 can be lifted and dragged to a desired location for exercising, and then turned to face the patient. In another non-limiting embodiment, a pair of rollers at either end 112a, 112b of base member 102 may be used to enhance mobility of assembly 100.

Further, a top portion of the lever 118 is attached to the base member 102, and a bottom portion of lever 118 detaches from base member 102 to counteract tilting forces as force is applied to displace the limb along the curvilinear path. In this manner, user 200 can apply great amounts of force on the vehicle 130 with the limb terminus 204 without tilting the assembly 100 over.

Looking now at FIG. 8, assembly 100 further comprises a bracket 124 that detachably attaches to recessed docking region 104 in base member 102. Bracket is configured to form a nexus and fastening means between rails 128a-d and base member 102. Bracket 124 enables rails 128a-d to be detached from base member 102.

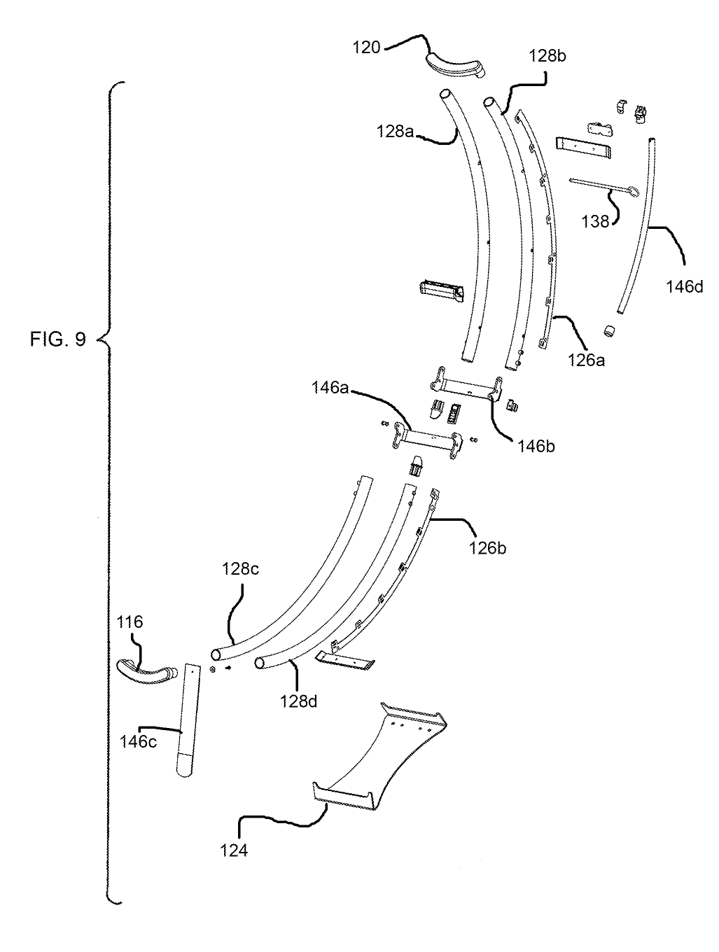

As FIG. 9 references, assembly 100 comprises a pair of curvilinear rails 128a-d disposed to extend along the length of base member 102. Rails 128a-d are defined by a generally curvilinear shape, and a substantially smooth surface that creates a low friction coefficient. The curved path is defined by a bend or inclination that is determined according to the purposes to be achieved through the resistive exercises and active exercises. It is this curvilinear path that the limb follows, which enables the unique range of motion for the joint 202 to achieve the active and resistive exercises.

A vehicle 130 rides along rails 128a-d that extend along the length of the smooth upper surface of rails 128a-d. Rails 128a-d are configured to engage at least one wheel 136a, 136b from a vehicle 130, as described below. The smooth surface of rails 128a-d allows the limb terminus 204, while coupled to the vehicle 130, to follow a smooth, continuous curvilinear path to allow the full range of motion for joint 202.

In one non-limiting embodiment, rails 128a-d are configured to separate into two sections 128a, 128c, and 128b, 128d, so as to telescopically slide relative to each other. In this manner, rails 128a-d may be length adjustably moved towards either of the extreme ends 112a-b of base member 102. A pair of rail brackets 146a, 146b forms a channel, and a pair of rail fasteners 146c, 146d help fasten the two sections of rail 128a, 128c, and 128b, 128d, for slidable engagement therebetween.

Assembly may further include a pin 138 that is operable to selectively fasten the sections of rails 128a-d in a fixed position relative to each other, once positioned to the desired length. Pin 138 may pass through holes in the sides of the rails 128a-d. In one non-limiting embodiment, rails 128a-d attach to a bracket 124 through multiple fasteners 140a, 140b, 140c, 140d, such as bolts, screws, nuts, adhesives, welds, and the like.

As illustrated in FIG. 1, the vehicle 130 is configured to be displaced by the limb terminus 204 while following the curvilinear path of rails 128a-d. Vehicle 130 includes a limb surface 132 that receives and detachably couples to limb terminus 204. In this manner, the foot can easily exert a force on vehicle 130 to move across curvilinear rails 128a-d in a smooth, continuous motion, and the joint 202 moves in the full range of motion allowed by the curvilinear path. A limb fastening mechanism 134 works to detachably fasten the limb terminus 204 to limb surface 132 of vehicle 130. Further, vehicle 130 includes a rail surface 122 that engages the curvilinear rails 128a-d. At least one wheel 136a-b from rail surface 122 of vehicle 130 rolls along the smooth upper surface of rails 128a-d.

In one non-limiting embodiment shown in FIG. 6, vehicle 130 may include at least one wheel 136a, 136b that rolls along the pair of rails 128a-d. In one embodiment, wheel 136a-b comprises two pairs of wheels rotating about an axis. Though in other embodiments, other mobility means known in the art may be used, including a single wheel, ball bearings, and blades. Wheels 136a-b are stabilized through use of a pair of wheel assemblies 144a, 144b, 144c, 144d including axles, wheel brackets, ball bearings, and the like.

Assembly 100 may further include a limb fastening mechanism 134 configured to enable detachable attachment of a limb to the limb surface 132 of vehicle 130. Limb fastening mechanism 134 ensures that the limb terminus 204, such as a foot, remains firmly secured to vehicle 130 as the limb flexes along the curvilinear path of rails 128a-d. Limb fastening mechanism 134 may include a hook and loop fastener with a buckle. For example, a strip of material that wraps around the foot. Though other limb fastening mechanisms known in the art may also be used.

Looking again at FIGS. 2 and 6, assembly 100 may further include an adjustment member 114 operatively connected to the at least one wheel 136a-b. Adjustment member 114 is configured to displace wheel 136a-b in a first direction to increase the friction coefficient between wheel 136a-b and rails 128a-d. Conversely, adjustment member 114 may displace wheel 136a-b in a second direction to decrease the friction coefficient between wheel 136a-b and rails 128a-d.

In one non-limiting embodiment, adjustment member 114 comprises a knob and gears that displace wheel 136a-b outwardly against the rails 128a-d when turned in the first direction, and inwardly displaces wheel 136a-b when turned in the second direction. In this manner, a limb, such as the knee, may exert a force along the curvilinear path within the closed kinetic path allowed by the curvilinear rails 128a-d. In this manner, the resistance to the joint 202 along the curvilinear motion may be adjusted accordingly. In this manner, assembly 100 is efficacious for providing resistance during range of motion to facilitate strengthening of quadriceps and hamstring, in addition to the joint exercises discussed above.

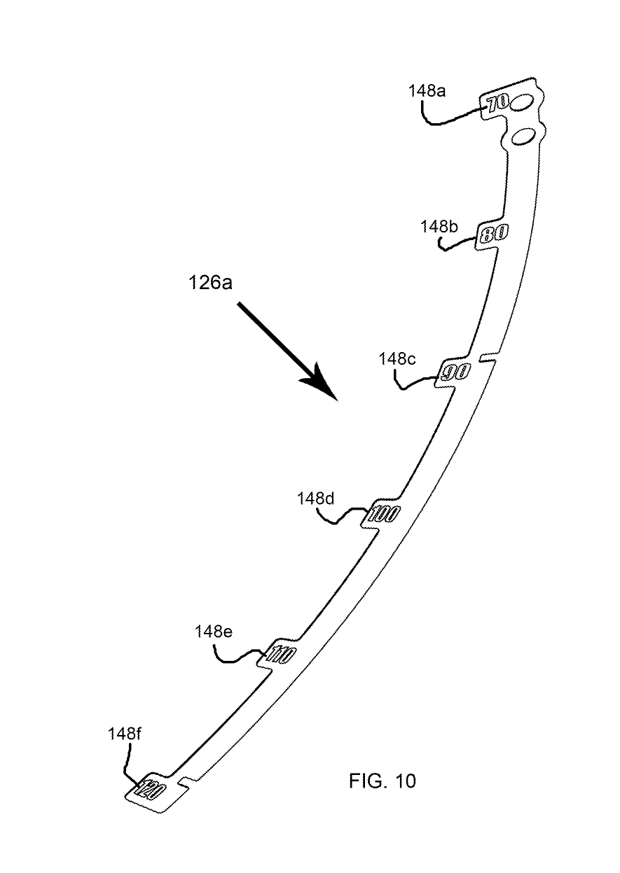

In one non-limiting embodiment shown in FIG. 10, assembly 100 provides at least one angle bar 126a, 126b. Angle bar 126a-b positions along the length of rails 128a-d to measure the radius angle of the vehicle 130 relative to rails 128a-d; and thereby allow a user to extend and retract the limb at a desired distance. To achieve this measurement, angle bar 126a-b may have multiple increment marks 148a-f that serve as measurements of the angles.

For example, 70° to 120° angles are marked in a spaced-apart relationship along the angle bar 126a-b. Exemplary increment marks 148a-f may include: a 70° mark 148a; a 80° mark 148b; a 90° mark 148c; a 100° mark 148d; a 110° mark 148e; a 120° mark 148f. In this manner, the user can extend the limb to a desired distance and adjust the rails 128a-d to a desired length to accommodate various user leg lengths, leg extension limitations, and friction coefficient resistance levels.

In operation, shown in FIG. 1, a user 200 may easily carry or drag the assembly 100 by gripping the lever 118. User 200 places a seat towards proximal end 116 of base member 102 and places limb terminus 204 in the vehicle 130. Limb fastening mechanism 134 wraps around the limb terminus 204 to secure the limb terminus 204 in place for exercise. User 200 exerts a force on limb terminus 204 to move the limb in a smooth, continuous motion across the rails 128a-d. The joint 202 perceives resistance while moving along this curvilinear path. The resistance between vehicle 130 and rails 128a-d may be adjusted by turning a knob in adjustment member 114.

Assembly 100, in this instance, may be very helpful for the patient in performing active range of motion independently without any assistance required from caregiver for set up. Further, the assembly 100 provides a friction free rail surface 128a-d; whereas patient may have to perform follow up exercises in bed with a bed sheet, carpet, or wooden floor which sometime causes friction that hinders smooth motion of the limbs. Additionally, assembly 100 is efficacious for providing resistance during range of motion to facilitate further strengthening of quadriceps and hamstring.

Further advantages of the assembly 100 are that it provides a lightweight, portable, compact and user friendly piece of exercise equipment that enables self-use for active and resisted ROM of knee joint, so as to promote increased circulation, healing and strength. Assembly 100 may also be easily setup by the patient, and does not require any assistance from the caregiver. Not only can assembly 100 be used at home but can also be used at professional settings by clinicians. Further, assembly is relatively inexpensive when compared to CPM or any other gym equipment.

In conclusion, as referenced in FIGS. 2-5, assembly 100 comprises three primary components: a base member 102, a pair of curvilinear rails 128a-b, and a vehicle 130 that work together to enable a joint 202, such as a knee or elbow, to flex in a curvilinear motion while following a curvilinear path, and also enabling adjustable resistance during the curvilinear motion. In this manner, assembly 100 enables joint 202 to practice both resistive exercises and active exercises for strengthening joint 202, as well as redeveloping range of motions for joint 202.

Assembly 100 provides a base member 102 that supports the assembly 100. Base member 102 has a recessed docking region 104 for receiving a curvilinear rails 128a-d. Rails 128a-d attach to the recessed docking region 104 through a bracket 124, which is detachably from base member 102. A lever 118 and a base handle 108a, 108b extend from base member 102 for moving assembly 100 and inhibiting tilting by assembly 100. A vehicle 130 having at least one wheel 136a-b, rides the rails 128a-d to enable the joint 202 to extend and retract in a smooth, continuous motion along curvilinear path of rails 128a-d. An adjustment member 114 increases and decreases the friction coefficient between wheel 136a-b and rails 128a-d to enable adjustable resistance.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. An active and resistive exercise joint rehabilitation assembly, the assembly comprising:
a base member defined by a narrow center region and a pair of base ends, the base member further defined by a recessed docking region;
a pair of stabilizer bars extending along the length of the base member;
a pair of rails defined by a generally curvilinear shape, the pair of rails further being defined by a distal end and a proximal end, the proximal end being joined with the base member;
a bracket joining the base member to the pair of rails;
a lever extending from the proximal end of the pair of rails, the lever being operable to help manipulate the assembly;
a base handle joined with the base ends of the base member, the base handle operable to extend and retract from the base member to help manipulate the assembly;
a vehicle defined by a limb surface and a rail surface, the rail surface comprising at least one wheel operable to ride the pair of rails;
a limb fastening mechanism operatively attached to the limb surface of the vehicle; and
an adjustment member operatively connected to the at least one wheel, the adjustment member being operable to increase the friction coefficient between the at least one wheel and the pair of rails, the adjustment member further being operable to decrease the friction coefficient between the at least one wheel and the pair of rails.

2. The assembly of claim 1, wherein the base handle has a generally T-shape.

3. The assembly of claim 1, wherein the base handle comprises a length adjustable handle configured for gripping.

4. The assembly of claim 1, wherein the lever is generally elongated and rigid.

5. The assembly of claim 1, wherein the lever manipulates the assembly in a tilting motion.

6. The assembly of claim 1, wherein the vehicle is sized and dimensioned to enable receiving a limb terminus.

7. The assembly of claim 1, wherein the bracket detachably attaches to the recessed docking region of the base member.

8. The assembly of claim 1, wherein the at least one wheel comprises at least four wheels.

9. The assembly of claim 1, wherein the limb fastening mechanism enables detachable attachment of a limb to the limb surface of the vehicle.

10. The assembly of claim 1, wherein the limb fastening mechanism is a hook and loop fastener.

11. The assembly of claim 1, wherein the adjustment member is operable to displace the at least one wheel in a first direction to increase the friction coefficient between the at least one wheel and the pair of rails.

12. The assembly of claim 1, wherein the adjustment member is operable to displace the at least one wheel in a second direction to decrease the friction coefficient between the at least one wheel and the pair of rails.

13. The assembly of claim 1, wherein the adjustment member comprises a knob.

14. The assembly of claim 1, further comprising a pin operable to selectively fasten the pair of rails in a fixed position relative to the base member.

15. The assembly of claim 1, further comprising at least one angle bar operable to indicate a position of the vehicle relative to the pair of rails.

16. The assembly of claim 15, wherein the at least one angle bar indicates a radius angle of the vehicle relative to the pair of rails.

17. An active and resistive exercise joint rehabilitation assembly, the assembly comprising:
a base member defined by a narrow center region and a pair of base ends being generally wider than the center region, the base member further defined by a recessed docking region;
a pair of stabilizer bars extending along the length of the base member;
a pair of rails defined by a generally curvilinear shape, the pair of rails further being defined by a distal end and a proximal end, the proximal end being joined with the base member;
a bracket detachably attached to the recessed docking region of the base member, the bracket joining the base member to the pair of rails;
a lever extending from the proximal end of the pair of rails, the lever being operable to help manipulate the assembly;
a base handle joined with the base ends of the base member, the base handle operable to extend and retract from the base member to help manipulate the assembly;
a vehicle defined by a limb surface and a rail surface, the rail surface comprising at least four wheels operable to ride the pair of rails;
a limb fastening mechanism operatively attached to the limb surface of the vehicle;
an adjustment member operatively connected to the at least four wheels, the adjustment member being operable to increase the friction coefficient between the at least four wheels and the pair of rails, the adjustment member further being operable to decrease the friction coefficient between the at least four wheels and the pair of rails; and
at least one angle bar operable to indicate a position of the vehicle relative to the pair of rails.

18. The assembly of claim 17, further comprising a pin operable to selectively fasten the pair of rails in a fixed position relative to the base member.

19. The assembly of claim 17, wherein the adjustment member is operable to displace the at least one wheel in a first direction to increase the friction coefficient between the at least one wheel and the pair of rails, the adjustment member further being operable to displace the at least one wheel in a second direction to decrease the friction coefficient between the at least one wheel and the pair of rails.

20. An active and resistive exercise joint rehabilitation assembly, the assembly consisting of:
a base member defined by a narrow center region and a pair of base ends being generally wider than the center region, the base member further defined by a recessed docking region;
a pair of stabilizer bars extending along the length of the base member for lateral stability to the base member;
a pair of stabilizer bar fasteners fastening the pair of stabilizer bars to the base member;
a pair of rails defined by a generally curvilinear shape, the pair of rails further being defined by a distal end and a proximal end, the proximal end being joined with the base member;
a pin operable to selectively fasten the pair of rails in a fixed position relative to the base member;
pair of rail brackets;
a pair of rail fasteners;
a bracket detachably attached to the recessed docking region of the base member, the bracket joining the base member to the pair of rails with multiple fasteners;
a lever extending from the proximal end of the pair of rails, the lever being operable to help manipulate the assembly in a tilting motion;
a base handle joined with the base ends of the base member, the base handle comprising a length adjustable handle configured for gripping, whereby the base handle is operable to extend and retract from the base member to help manipulate the assembly;
a vehicle being sized and dimensioned to enable receiving a limb terminus, the vehicle defined by a limb surface and a rail surface, the rail surface comprising at least one wheel operable to ride the pair of rails;
a pair of wheel assemblies operatively joined with the pair of wheels for stabilizing the wheels;
a limb fastening mechanism operatively attached to the limb surface of the vehicle;
an adjustment member operatively connected to the at least one wheel, the adjustment member being operable to displace the at least one wheel in a first direction to increase the friction coefficient between the at least one wheel and the pair of rails, the adjustment member further being operable to displace the at least one wheel in a second direction to decrease the friction coefficient between the at least one wheel and the pair of rails; and
at least one angle bar operable to indicate a radius angle of the vehicle relative to the pair of rails, the at least one angle bar comprising multiple increment marks.
